(19) United States
(12) Patent Application Publication
(10) Pub. No.: US 2008/0307857 A1
(43) Pub. Date: Dec. 18, 2008

(54) LEAK DETECTION WITHIN THE INTERIOR OF A CABINET

(76) Inventor: Binyamin Atiya, Binyamina (IL)

Correspondence Address: YORAM TSIVION, P.O. BOX 1307, PARDES HANNA, 37111, IL

(21) Appl. No.: 12/141,119

(22) Filed: Jun. 18, 2008

(30) Foreign Application Priority Data
Jun. 18, 2007 (IL) 184010

(51) Int. Cl. G01M 3/04; B65D 1/34

(52) U.S. Cl. 73/40; 220/571

(57) ABSTRACT

A drainage tray for detecting leaks from a sink is provided. The drainage tray includes a tray for intercepting the leaks, a trough for collecting the intercepted leaks. The outlet in the trough discharges the collected leaks from the trough.

### FIELD OF THE INVENTION

The present invention is in the field of leak detection in plumbing pipes. More specifically the present invention relates to water leakage detection and disposal of leakage water beneath a kitchen sink.

### BACKGROUND OF THE INVENTION

In plumbing, a sink is a bowl-shaped fixture, usually made of porcelain or stainless steel that is used for washing hands or small objects such as dishes. Sinks generally have faucets and a drain. The drain is a plumbing structure (PS) that is housed below the sink and often within an interior of a cabinet and is used for carrying waste water into a drainage system. Unfortunately, the PS frequently fails, allowing leaks, sometimes causing damage to the cabinet or house walls, floors and utensils stored in the cabinet, as well as general inconvenience. Sometimes the amount of water leakage is so small that it is impossible to detect the water leakage since the PS is housed in an interior of a cabinet. Therefore, a simple and inexpensive apparatus for detecting and collecting water or other liquids that leak from a PS is desirable.

US patent application 2002/0095721, the content of which is incorporated herewith by reference, discloses a system adapted to be mounted on waterline beneath a sink, for detecting any leaks and shutting off the flow water to avoid leakage. The system includes a leak detecting portion and one or more waterline shutoff devices for mounting in one or more waterlines.

### BRIEF DESCRIPTION OF THE DRAWINGS

FIG. 1 is an isometric view of a drainage tray in accordance with a preferred embodiment of the present invention;

FIG. 2 is an isometric view of a PS leakage detector system in accordance with a preferred embodiment of the present invention installed within an interior of a cabinet;

FIG. 3 is an axial sectional view of the PS leakage detector system in accordance with a preferred embodiment of the present invention installed within an interior of a cabinet;

### DETAILED DESCRIPTION OF THE PRESENT INVENTION

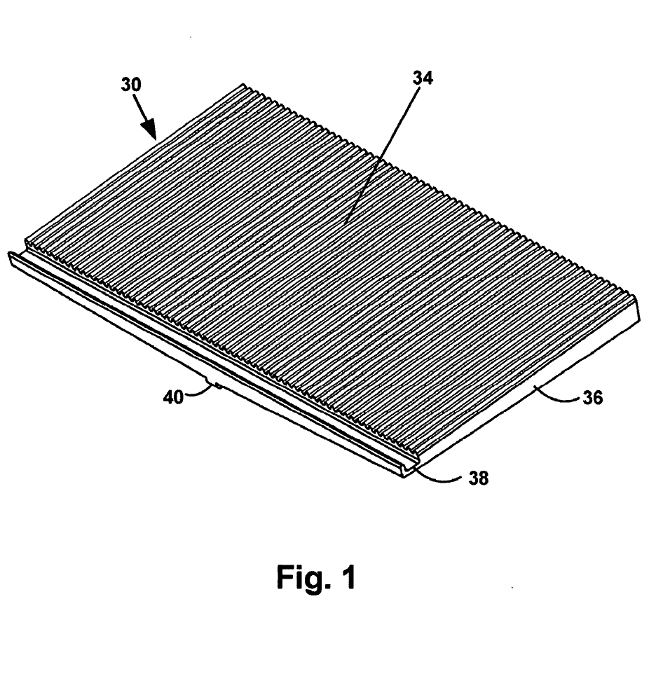

In accordance with the present invention a leak detector of a PS housed below a sink and typically enclosed within a cabinet is provided. An exemplary drainage-tray in accordance with a preferred embodiment of the present invention is shown in FIG. 1 to which reference is now made. Drainage-tray 30 is made of materials as known in the art of plumbing, such as but not limited to plastic or stainless steel. Trays are may prepared in several predefined sizes to fit different sizes of a sink cabinet. Another option is to prepare a drainage-tray with material which may be conveniently trimmed. Tray 30 is typically densely furrowed at top side surface 34. Tray 30 is slanted as can be seen by the triangular shape of wall 36, such that a liquid intercepted by the densely furrowed surface collects into trough 38 to be discharged through outlet 40. In other embodiments of the invention, surface 34 is shaped differently, providing that the geometric features promote draining the liquid into trough 38.

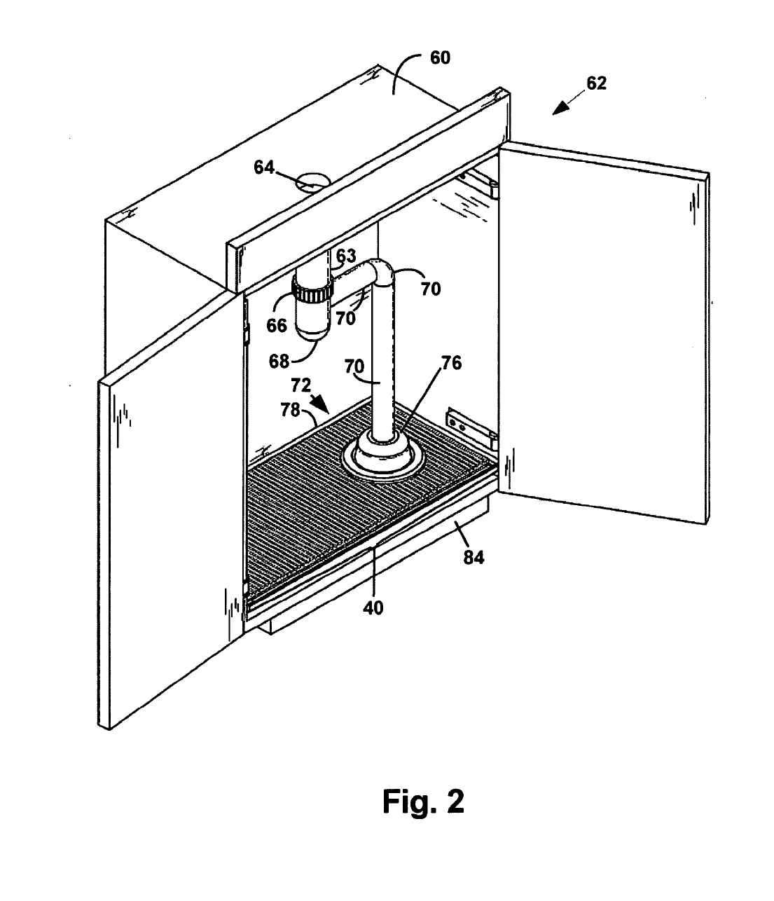

An isometric view of PS leakage detector in accordance with a preferred embodiment of the present invention installed within an interior of a cabinet is shown in FIG. 2 to which reference is now made. A sink, not shown, is mounted on top side surface 60 of cabinet 62. Waste water absorbed by the sink is drained through hose 63 which is part of the PS. The hose passes through hole 64 and is connected in one end to outlet of the sink, not shown in FIG. 2. The PS typically further includes drain-flange 66, waste-trap 68 and other hose segments for carrying the waste water into a drainage system. The PS leakage detector in accordance to the preferred embodiment of the present invention includes drainage-tray 72 and in cases in which a hose of a PS is connected to the sewage system through the bottom surface of the cabinet, water seal 76 is included. The water seal is made of materials as known in the art of plumbing, such as plastic, rubber or combination thereof. Rubber boundary 78 or other water confining means is disposed around the edges of the drainage tray in order that water will not leak beyond the edges of the tray. In accordance with one embodiment of the present invention outlet 40 is disposed near the edge of cabinet floor 80 beyond floor spacer 84 such that the waste water collected by the drainage tray is drained to a site outside of the limits of the front of floor spacer 84. The presence of a leak is typically indicated by the appearance of drained water.

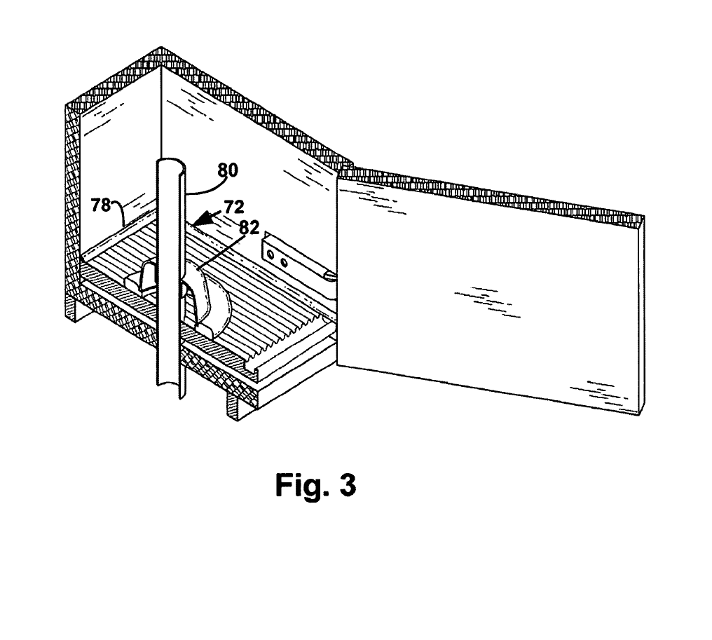

In some embodiments of the present invention a conduit is connected to outlet 40 such that the leaks from the PS flow through the conduit, to be disposed of. An axial sectional view of the PS leakage detector in accordance with a preferred embodiment of the present invention installed within the interior of the cabinet is shown in FIG. 3 to which reference is now made. Hose 80 which is part of the PS passes through water seal 82.

In another aspect of the present invention a planar upper tray is installed above the drainage tray substantially in parallel to the cabinet's floor. Such planar upper tray is permeable to liquids. An example of such planar tray is a mesh surface which is preferably is made of plastic resin or stainless steel.

1. A drainage tray for detecting leaks from a plumbing structure draining a sink, said tray comprising:
a tray for intercepting leaks of said plumbing structure;
a trough for collecting said intercepted leaks;
an outlet in said trough for discharging said collected leaks from said trough.

2. A drainage tray for detecting leaks from a plumbing structure as in claim 1 wherein said tray has a densely furrowed top side.

3. A drainage tray for detecting leaks from a plumbing structure as in claim 1 further comprising a conduit connected to said outlet.

4. A drainage-tray for detecting leaks from a plumbing structure as in claim 1 further comprising a planar upper tray installed above said drainage-tray and wherein said upper tray has a surface permeable to liquids.

5. A drainage-tray for detecting leaks from a plumbing structure as in claim 4 wherein said upper tray is a mesh.

6. A drainage-tray for detecting leaks from a plumbing structure as in claim 1, having an aperture wherein a portion of said plumbing passes through said aperture.

7. A drainage-tray for detecting leaks from a plumbing structure as in claim 6, is further furnished with a water seal for sealing said, portion of said plumbing and said drainage tray.

8. A drainage tray for detecting leaks from a plumbing structure as in claim 1 wherein said drainage-tray is slanted.

9. A drainage-tray for detecting leaks in a plumbing structure as in claim 1 wherein a water confining means is disposed around the edges of said drainage-tray.

10. A method for detecting leaks from a plumbing structure housed below a sink, said method is comprising:
intercept leak from a plumbing structure by a top side of drainage tray;
collecting said leaks into a trough of said drainage-tray;
discharging said collected leaks through an outlet of said trough and wherein said discharged leaks indicate the presence of said leak.

11. A method for detecting leaks from a plumbing structure housed below a sink as in claim 10, wherein said top side surface is densely furrowed.

12. A method for detecting leaks from a plumbing structure housed below a sink as in claim 10, wherein said drainage tray is slanted.

13. A method for detecting leaks from a plumbing structure housed below a sink as in claim 10, further comprising liquid sealing said drainage tray such that the liquid leak is disposed of substantially through said outlet.
